(19) United States
(12) Patent Application Publication
(10) Pub. No.: US 2025/0138200 A1
(43) Pub. Date: May 1, 2025

(54) CORRECTION SYSTEM, TERMINAL APPARATUS, PROGRAM TO CORRECT OUTPUT OF THREE-AXIS ANGULAR SPEED SENSOR AND THREE-AXIS ACCELERATION SENSOR

(71) Applicant: JVCKENWOOD Corporation, Yokohama-shi (JP)

(72) Inventor: Takahiro KONDOH, Yokohama-shi (JP)

(21) Appl. No.: 19/008,703

(22) Filed: Jan. 3, 2025

Related U.S. Application Data
(63) Continuation of application No. PCT/JP2023/024245, filed on Jun. 29, 2023.

(30) Foreign Application Priority Data
Jul. 14, 2022 (JP) 2022-113368

(51) Int. Cl. G01S 19/45; G01S 19/40

(52) U.S. Cl. CPC G01S 19/45; G01S 19/40

(57) ABSTRACT

A server searches for a first initial value, a second initial value, a third initial value, and a fourth initial value. A terminal apparatus searches for an offset of a three-axis angular speed sensor based on the first initial value, searches for a sensitivity coefficient of the three-axis angular speed sensor based on the second initial value, searches for an offset of a three-axis acceleration sensor based on the third initial value, and searches for the sensitivity coefficient of the three-axis acceleration sensor based on the fourth initial value. The terminal apparatus derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.

### CROSS-REFERENCE TO RELATED APPLICATION

This application is based upon and claims the benefit of priority from the prior Japanese Patent Application No. 2022-113368, filed on Jul. 14, 2022, the entire contents of which is incorporated herein by reference.

### BACKGROUND

### 1. Technical Field

The present disclosure relates to a correction technology and, in particular, to a correction system, a terminal apparatus, and a program for correcting an output of a three-axis angular speed sensor and a three-axis acceleration sensor.

### 2. Description of the Related Art

One of the causes of positioning errors in an angular speed sensor is the presence of an offset in the angular speed sensor. To reduce the effect of an offset of the angular speed sensor, it is necessary to calibrate the angular speed sensor, but the calibration process is generally cumbersome for the angular speed sensor. Therefore, it is difficult to execute calibration easily. To execute calibration easily in a system consisting of a mobile terminal and a server, the offset of the angular speed sensor mounted on the mobile terminal is corrected by the server. In such a configuration, the processing amount in the mobile terminal does not increase, but the processing amount in the server increases. To suppress the increase in the processing amount in the server, calibration is executed only when the movable object moves by a predetermined amount of movement and a predetermined angle or more (see, for example, Patent Literature 1).
[Patent Literature 1] JP2012-215547

Considering the efficiency of the system as a whole, it is preferable to execute calculation on the terminal side as well.

### SUMMARY

A correction system according to an embodiment of the present disclosure includes: a terminal apparatus comprising a three-axis angular speed sensor, a three-axis acceleration sensor, and a GNSS (Global Navigation Satellite System) positioning unit; and a server capable of communicating with the terminal apparatus. The terminal apparatus transmits a first output value of the three-axis angular speed sensor, a second output value of the three-axis acceleration sensor, and a positioning result of the GNSS positioning unit to the server, the server uses the first output value, the second output value, and the positioning result to search for a first initial value of an offset of the three-axis angular speed sensor within a first initial tolerable range, search for a second initial value of a sensitivity coefficient of the three-axis angular speed sensor within a second initial tolerable range, search for a third initial value of an offset of the three-axis acceleration sensor within a third initial tolerable range, and search for a fourth initial value of a sensitivity coefficient of the three-axis acceleration sensor within a fourth initial tolerable range, the server transmits the first initial value, the second initial value, the third initial value, the fourth initial value, the first initial tolerable range, the second initial tolerable range, the third initial tolerable range, and the fourth initial tolerable range to the terminal apparatus, the terminal apparatus uses a new first output value, a new second output value, and a new positioning result to search for the offset of the three-axis angular speed sensor based on the first initial value within a first tolerable range narrower than the first initial tolerable range, search for the sensitivity coefficient of the three-axis angular speed sensor based on the second initial value within a second tolerable range narrower than the second initial tolerable range, search for the offset of the three-axis acceleration sensor based on the third initial value within a third tolerable range narrower than the third initial tolerable range, and search for the sensitivity coefficient of the three-axis acceleration sensor based on the fourth initial value within a fourth tolerable range narrower than fourth initial tolerable range the fourth initial tolerable range, and the terminal apparatus derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.

Another embodiment of the present disclosure relates to a terminal apparatus. The apparatus includes: a three-axis angular speed sensor; a three-axis acceleration sensor; a GNSS (Global Navigation Satellite System) positioning unit; a communication unit that transmits a first output value of the three-axis angular speed sensor, a second output value of the three-axis acceleration sensor, and a positioning result of the GNSS positioning unit to the server, and uses the first output value, the second output value, and the positioning result to receive a first initial value of an offset of the three-axis angular speed sensor searched for within a first initial tolerable range, a second initial value of a sensitivity coefficient of the three-axis angular speed sensor searched for within a second initial tolerable range, a third initial value of an offset of the three-axis acceleration sensor searched for within a third initial tolerable range, and a fourth initial value of a sensitivity coefficient of the three-axis acceleration sensor searched for within a fourth initial tolerable range; and a processing unit that i) uses a new first output value, a new second output value, and a new positioning result to search for the offset of the three-axis angular speed sensor based on the first initial value within a first tolerable range narrower than the first initial tolerable range, search for the sensitivity coefficient of the three-axis angular speed sensor based on the second initial value within a second tolerable range narrower than the second initial tolerable range, search for the offset of the three-axis acceleration sensor based on the third initial value within a third tolerable range narrower than the third initial tolerable range, and search for the sensitivity coefficient of the three-axis acceleration sensor based on the fourth initial value within a fourth tolerable range narrower than fourth initial tolerable range the fourth initial tolerable range and ii) derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.

Optional combinations of the aforementioned constituting elements, and implementations of the disclosure in the form of methods, apparatuses, systems, recording mediums, and computer programs may also be practiced as additional modes of the present disclosure.

According to the present disclosure, the angular speed can be efficiently derived.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a correction system according to the exemplary embodiment.

FIG. 2 shows the coordinate system according to the exemplary embodiment.

FIGS. 3A-3B show an overview of the process in the processing unit of FIG. 1.

FIG. 4 shows a data structure of a database generated by the statistical processing unit of FIG. 1.

FIG. 5 shows a data structure of another database generated by the statistical processing unit of FIG. 1.

FIG. 6 shows a data structure of a database stored in the storage unit of FIG. 1.

FIG. 7 is a sequence chart showing the steps of deriving the angular speed by the correction system of FIG. 1.

FIG. 8 is a flowchart showing the steps of deriving the offset and the sensitivity coefficient by the server of FIG. 1.

FIG. 9 is a flowchart showing the steps of deriving the third initial value by the server of FIG. 1.

### DETAILED DESCRIPTION

The invention will now be described by reference to the preferred embodiments. This does not intend to limit the scope of the present invention, but to exemplify the invention.

A brief summary will be given before describing the present disclosure in specific details. An exemplary embodiment relates to a correction system mounted on a vehicle, etc. and including a terminal apparatus equipped with an angular speed sensor and an acceleration sensor and including a server that receives data of the sensors from the terminal apparatus. In the correction system, the task of determining the offset and the sensitivity of the angular speed sensor and the offset and the sensitivity of the acceleration sensor is shared between the server and the terminal apparatus. For example, the server executes a process that requires a large processing amount, and the terminal apparatus executes a process that requires a smaller processing amount than the server.

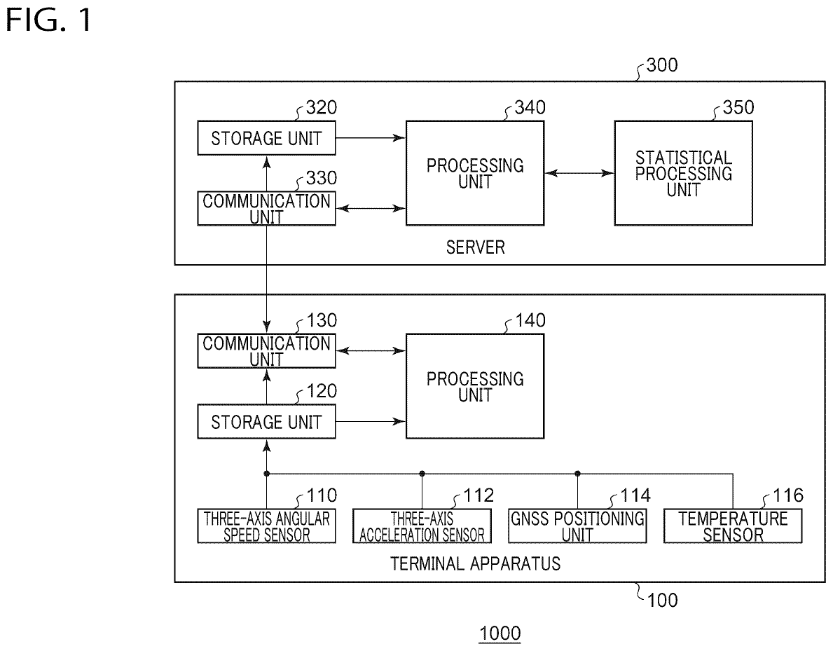

FIG. 1 shows a configuration of a correction system 1000. The correction system 1000 includes a terminal apparatus 100 and a server 300. The server 300 and the terminal apparatus 100 need not be those provided by the same contractor. The terminal apparatus 100 includes a three-axis angular speed sensor 110, a three-axis acceleration sensor 112, a GNSS (Global Navigation Satellite System) positioning unit 114, a temperature sensor 116, a storage unit 120, a communication unit 130, and a processing unit 140. The server 300 includes a storage unit 320, a communication unit 330, a processing unit 340, and a statistical processing unit 350. The terminal apparatus 100 can be mounted on a vehicle not shown.

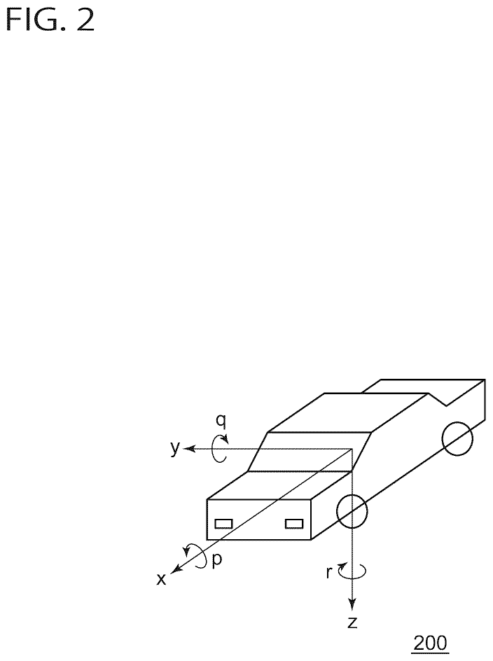

The three-axis angular speed sensor 110 measures the angular speed corresponding to each of the three axes and sequentially outputs each measured speed to the storage unit 120 as an output value (hereinafter referred to as “first output value”). FIG. 2 is used here to illustrate the three axes. FIG. 2 shows the coordinate system according to the exemplary embodiment. A Cartesian coordinate system consisting of the three axes, i.e., the x-axis, the y-axis, and the z-axis is defined. The x-axis is aligned with the direction of travel of the vehicle 200, the z-axis is aligned with the normal direction downward from the floor surface of the vehicle 200, and the y-axis is aligned with a direction perpendicular to the x-axis and the z-axis. The angular speed vector ω is denoted by [pqr]^{T}, wherein p denotes the angular speed around the x-axis, q denotes the angular speed around the y-axis, and r denotes the angular speed around the z-axis. Reference is made back to FIG. 1.

The three-axis acceleration sensor 112 measures the acceleration corresponding to each of the three axes and sequentially outputs the measured acceleration to the storage unit 120 as an output value (hereinafter referred to as “second output value”). The acceleration includes the acceleration ax in the x-axis direction, the acceleration a_{y} in the y-axis direction, the acceleration a_{z} in the z-axis direction.

The GNSS positioning unit 114 receives a signal from a GNSS satellite and acquires satellite navigation data by satellite navigation. Satellite navigation data includes latitude, longitude, speed, and orientation. The GNSS positioning unit 114 sequentially outputs satellite navigation data (hereinafter referred to as “positioning result”) to the storage unit 120. The temperature sensor 116 measures the temperature and sequentially outputs the measured temperature to the storage unit 120 as an output value (hereinafter referred to as the “third output value”).

The storage unit 120 associates and stores the first output value, the second output value, the positioning result, and the third output value. The communication unit 130 can perform wireless communication, and sequentially transmits the first output value, the second output value, the positioning result, and the third output value to the server 300 as measurement data.

The communication unit 330 of the server 300 can communicate with the terminal apparatus 100 and receives the measurement data sequentially from the terminal apparatus 100. The storage unit 320 sequentially associates and stores the measurement data received by the communication unit 330, i.e., the first output value, the second output value, the positioning result, and the third output value.

The processing unit 340 uses the first output value, the second output value, and the positioning result stored in the storage unit 320 to determine the initial value of the offset of the three-axis angular speed sensor 110 (hereinafter referred to as the “first initial value”), the initial value of the sensitivity coefficient of the three-axis angular speed sensor 110 (hereinafter referred to as the “second initial value”), the initial value of the offset of the three-axis acceleration sensor 112 (hereinafter referred to as the “third initial value”), and the initial value of the sensitivity coefficient of the three-axis acceleration sensor 112 (hereinafter referred to as the “fourth initial value”). The process in the processing unit 340 will be described in the order of (1) the basic process for deriving the angular speed, and (2) the process for determining the initial value of the offset and the sensitivity coefficient.

### (1) Basic Process for Deriving the Angular Speed

The initial attitude is derived in an Euler angle representation based on the output value and the offset of the three-axis acceleration sensor 112. In the Eulerian angle representation, the rotation angle around the x-axis is called the roll angle φ, the rotation angle around the y-axis is called the pitch angle θ, and the rotation angle around the z-axis is called the yaw angle Ψ. The φ and θ of the initial attitude are given as follows.

$$ϕ = {tan}^{- 1} ( \frac{{a}_{y}}{{a}_{z}} ) θ = {tan}^{- 1} ( \frac{{a}_{x}}{\sqrt{{a}_{y}^{2} + {a}_{z}^{2}}} ) \qquad ( 1 )$$

where ax, a_{y}, a_{z} denote accelerations in the x-axis, y-axis, and z-axis directions, respectively, and are represented as follows.

$${a}_{x} = AcclX\_sns ( AcclX\_out - AcclX\_ofs ) {a}_{y} = AcclY\_sns ( AcclY\_out - AcclY\_ofs ) {a}_{z} = AcclZ\_sns ( AcclZ\_out - AcclZ\_ofs ) \qquad ( 2 )$$

AcclX_sns, AcclY_sns, AcclZ_sns denote the sensitivity coefficient of the three-axis acceleration sensor 112 in the x-axis direction, the sensitivity coefficient of the three-axis acceleration sensor 112 in the y-axis direction, and the sensitivity coefficient of the three-axis acceleration sensor 112 in the z-axis direction. AcclX_out, AcclY_out, AcclZ_out denote the output value of the three-axis acceleration sensor 112 in the x-axis direction, the output value of the three-axis acceleration sensor 112 in the y-axis direction, and the output value of the three-axis acceleration sensor 112 in the z-axis direction. AcclX_out, AcclY_out, AcclZ_out correspond to the above-described second output values. AcclX_ofs, AcclY_ofs, AcclZ_ofs denote the offset of the three-axis acceleration sensor 112 in the x-axis direction, the offset of the three-axis acceleration sensor 112 in the y-axis direction, and the offset of the three-axis acceleration sensor 112 in the z-axis direction. The initial value of Ψ may be an arbitrary value and is set to, for example, “0”.

The initial attitude in the Euler angle representation is converted into the initial attitude in the direction cosine matrix representation, and the initial attitude in the direction cosine matrix representation is converted into the initial attitude in the quaternion representation. The initial attitude in the Euler angle representation is converted as follows by using the directional cosine matrix E:

$$\begin{matrix}E = [ \begin{matrix}1 & 0 & 0 \\ 0 & cos ϕ & sin ϕ \\ 0 & - s in ϕ & cos ϕ\end{matrix} ] [ \begin{matrix}cos θ & 0 & - sin θ \\ 0 & 1 & 0 \\ sin θ & 0 & cos θ\end{matrix} ] [ \begin{matrix}cos ψ & sin ψ & 0 \\ - s in ψ & cos ψ & 0 \\ 0 & 0 & 1\end{matrix} ] \\ = [ \begin{matrix}cos θ cos ψ & cos θ sin ψ & - sin θ \\ sin ϕ sin θ cos ψ - cos ϕ sin ψ & sin ϕ sin θ sin ψ + cos ϕ cos ψ & sin ϕ cos θ \\ cos ϕ sin θ cos ψ + sin ϕ sin ψ & cos ϕ sin θ sin ψ - sin ϕ cos ψ & cos ϕ cos θ\end{matrix} ]\end{matrix} \qquad ( 3 )$$

Further, the components of the directional cosine matrix E are given as follows.

$$E = [ \begin{matrix}{E}_{11} & {E}_{12} & {E}_{13} \\ {E}_{21} & {E}_{22} & {E}_{23} \\ {E}_{31} & {E}_{32} & {E}_{33}\end{matrix} ] \qquad ( 4 )$$

A quaternion is defined by four components, i.e., the unit vectors in the directions of rotation and the angle of rotation. The initial attitude in the directional cosine matrix E representation is converted into the initial attitude q₁, q₂, q₃, q₄ in the quaternion representation as follows.

$${q}_{{4}^{=}} \pm \frac{1}{2} \sqrt{1 + {E}_{11} + {E}_{22} + {E}_{33}} {q}_{1} = \frac{1}{4 {q}_{4}} ( {E}_{23} - {E}_{32} ) {q}_{2} = \frac{1}{4 {q}_{4}} ( {E}_{31} - {E}_{13} ) {q}_{3} = \frac{1}{4 {q}_{4}} ( {E}_{1 {2}^{-}} {E}_{21} ) \qquad ( 5 )$$

The initial attitude q₁, q₂, q₃, q₄ in the quaternion representation is then updated with the angular speed vector ω. As mentioned above, the angular speed vector ω=[pqr]^{T}. The components p, q, r are as shown in FIG. 2 and are given as follows.

$$p = GyroX\_sns ( GyroX\_out - GyroX\_ofs ) q = GyroY\_sns ( GyroY\_out - GyroY\_ofs ) r = GyroZ\_sns ( GyroZ\_out - GyroZ\_ofs ) \qquad ( 6 )$$

GyroX_sns, GyroY_sns, GyroZ_sns are the sensitivity coefficient of the three-axis angular speed sensor 110 in the x-axis direction, the sensitivity coefficient of the three-axis angular speed sensor 110 in the y-axis direction, and the sensitivity coefficient of the three-axis angular speed sensor 110 in the z-axis direction. GyroX_out, GyroY_out, GyroZ_out are the output value of the three-axis angular speed sensor 110 in the x-axis direction, the output value of the three-axis angular speed sensor 110 in the y-axis direction, and the output value of the three-axis angular speed sensor 110 in the z-axis direction. GyroX_out, GyroY_out, GyroZ_out correspond to the first output values described above. GyroX_ofs, GyroY_ofs, GyroZ_ofs are the offset of the three-axis angular speed sensor 110 in the x-axis direction, the offset of the three-axis angular speed sensor 110 in the y-axis direction, and the offset of the three-axis angular speed sensor 110 in the z-axis direction.

The following differential equation of the attitude in the quaternion representation is solved.

$$\frac{d}{d t} [ \begin{matrix}{q}_{1} \\ {q}_{2} \\ {q}_{3} \\ {q}_{4}\end{matrix} ] = \frac{1}{2} [ \begin{matrix}0 & r & - q & p \\ - r & 0 & p & q \\ q & - p & 0 & r \\ - p & - q & - r & 0\end{matrix} ] [ \begin{matrix}{q}_{1} \\ {q}_{2} \\ {q}_{3} \\ {q}_{4}\end{matrix} ] \qquad ( 7 )$$

In the initial stage, the initial attitude q₁, q₂, q₃, q₄ in the quaternion representation is substituted as the initial values into the right side of the differential equation, and the components p, q, r of the angular speed vector at that point of time are also substituted into the right side of the differential equation. By solving the differential equation, the attitude q₁, q₂, q₃, q₄ in the quaternion representation is updated.

Subsequently, the attitude q₁, q₂, q₃, q₄ in the quaternion representation thus derived is substituted into the right side of the differential equation, and the components of the new angular speed vector p, q, r are also substituted into the right side of the differential equation. By solving the differential equation, the attitude q₁, q₂, q₃, q₄ in the quaternion representation is updated again. That is, the attitude q₁, q₂, q₃, q₄ in the quaternion representation is updated sequentially by repeatedly solving the differential equation of the attitude in the quaternion representation while sequentially substituting the output value of the three-axis angular speed sensor 110 into the equation.

The updated attitude q₁, q₂, q₃, q₄ in the quaternion representation is converted into the attitude in the direction cosine matrix E representation, and then the attitude in the direction cosine matrix E representation is converted into the attitude in the Euler angle representation. The updated attitude q₁, q₂, q₃, q₄ in the quaternion representation is converted into the attitude in the direction cosine matrix E representation as follows:

$$E = [ \begin{matrix}{q}_{1}^{2} - {q}_{2}^{2} - {q}_{3}^{2} + {q}_{4}^{2} & 2 ( {q}_{1} {q}_{2} + {q}_{3} {q}_{4} ) & 2 ( {q}_{1} {q}_{3} - {q}_{2} {q}_{4} ) \\ 2 ( {q}_{1} {q}_{2} - {q}_{3} {q}_{4} ) & - {q}_{1}^{2} + {q}_{2}^{2} - {q}_{3}^{2} + {q}_{4}^{2} & 2 ( {q}_{2} {q}_{3} + {q}_{1} {q}_{4} ) \\ 2 ( {q}_{1} {q}_{3} + {q}_{2} {q}_{4} ) & 2 ( {q}_{2} {q}_{3} - {q}_{1} {q}_{4} ) & - {q}_{1}^{2} - {q}_{2}^{2} + {q}_{3}^{2} + {q}_{4}^{2}\end{matrix} ] \qquad ( 8 )$$

The directional cosine matrix E is converted into the attitude in the Euler angle representation as follows:

$$ϕ = {tan}^{- 1} \frac{{E}_{23}}{{E}_{33}} θ = {tan}^{- 1} \frac{- {E}_{13}}{\sqrt{{E}_{23}^{2} + {E}_{33}^{2}}} ψ = {tan}^{- 1} \frac{{E}_{12}}{{E}_{11}} \qquad ( 9 )$$

The angular speed is derived based on the time variation t [sec] of the yaw angle Ψ constituting attitude in the Euler angle representation. Denoting the yaw angle at time n of interest as Ψₙ, and the yaw angle at time n−1 as Ψₙ₋₁, for example, the angular speed is derived by (Ψₙ−Ψₙ₋₁)/t.

### (2) Process for Determining the Initial Value of the Offset and the Sensitivity Coefficient

To derive the angular speed as described above, parameters such as the offset (GyroX_ofs, GyroY_ofs, GyroZ_ofs) of the three-axis angular speed sensor 110, the sensitivity coefficient (GyroX_sns, GyroY_sns, GyroZ_sns) of the three-axis angular speed sensor 110, the offset (AcclX_ofs, AcclY_ofs, AcclZ_ofs) of the three-axis acceleration sensor 112, and the sensitivity coefficient (AcclX_sns, AcclY_sns, AcclZ_sns) of the three-axis acceleration sensor 112 are required. The processing unit 340 determines the initial values of these parameters and outputs the determined initial values to the terminal apparatus 100. The terminal apparatus 100 determines the parameters by updating the initial values. The initial value of the offset of the three-axis angular speed sensor 110, the initial value of the sensitivity coefficient of the three-axis angular speed sensor 110, the initial value of the offset of the three-axis acceleration sensor 112, and the initial value of the sensitivity coefficient of the three-axis acceleration sensor 112 correspond to the first initial value through the fourth initial value described above. The first initial value through the fourth initial value are collectively referred to as the initial value.

Hereinafter, the process for determining the initial value of the parameter will be described in the order of (2-1) overview and (2-2) search process.

### (2-1) Overview

The processing unit 340 does not derive the first initial value through the fourth initial value at the same time but derives them sequentially. For example, (i) the process for the offset of the three-axis angular speed sensor 110, (ii) the process for the offset of the three-axis acceleration sensor 112, (iii) the process for the sensitivity coefficient of the three-axis angular speed sensor 110, and (iv) the process for the sensitivity coefficient of the three-axis acceleration sensor 112 are executed in order. In these processes, the first initial value is determined in (i), the third initial value is determined in (ii), the second initial value is determined in (iii), and the fourth initial value is determined in (iv). Further, the processing unit 340 repeats (i) through (iv) as one lap and repeats the lap multiple times. As a result, the initial values are updated.

### (2-2) Search Process

Hereinafter, (2-2-1) the process in the first lap, (2-2-2) the process in the second and subsequent laps will be described in that order.

### (2-2-1) Process in the First Lap

### (2-2-1-1) Process for the Offset of the Three-Axis Angular Speed Sensor 110

The angular speed vector ω=[pqr]^{T} is given by expression (6). In the case the vehicle 200 is stationary, ω, i.e., each of p, q, r is “0”. From this, the following relationship holds.

GyroX_out=GyroX_ofs

GyroY_out=GyroY_ofs

GyroZ_out=GyroZ_ofs

The output value of the three-axis angular speed sensor 110 in the x-axis direction is equal to the offset of the three-axis angular speed sensor 110 in the x-axis direction. Therefore, the processing unit 340 derives the initial value of the offset of the three-axis angular speed sensor 110 in the x-axis direction when the vehicle 200 is at a stop by averaging the output values of the three-axis angular speed sensor 110 in the x-axis direction. The stop of the vehicle 200 may be detected by referring to the speed output by the GNSS positioning unit 114 or may be detected by a speed sensor (not shown). The processing unit 340 also derives the initial value of the offset of the three-axis angular speed sensor 110 in the y-axis direction and the initial value of the offset of the three-axis angular speed sensor 110 in the z-axis direction, by applying a similar process to the other components. The initial values thus derived are the first initial values described above.

### (2-2-1-2) Process for the Offset of the Three-Axis Acceleration Sensor 112

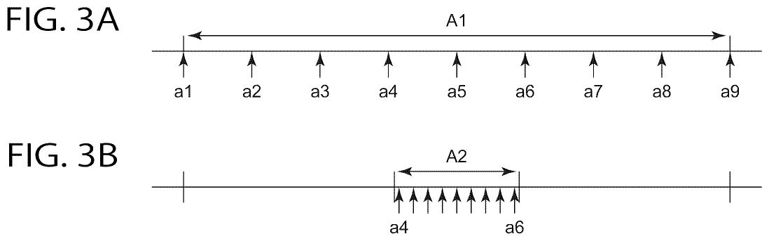

In this case, AcclX_ofs, AcclY_ofs, AcclZ_ofs in expression (2) are the parameters to be determined. The processing unit 340 sets an initial tolerable range as a range of values that can be taken by AcclX_ofs and places candidate values for the offset of the plurality of three-axis acceleration sensors 112 within the range. FIGS. 3A-3B show an overview of the process in the processing unit 340. Referring to FIG. 3A, the initial tolerable range is denoted by “A1”, and nine candidate values “a1” through “a9” are evenly spaced in the initial tolerable range. The number of candidate values is not limited to “9”. The same applies to AcclY_ofs, AcclZ_ofs. FIG. 3B will be described later, and reference is made back to FIG. 1.

The processing unit 340 assumes that AcclX_sns, AcclY_sns, AcclZ_sns in expression (2) are equal. With this assumption, AcclX_sns, AcclY_sns, AcclZ_sns cancel each other in expression (1). Further, AcclX_out, AcclY_out, AcclZ_out are the second output values. As a result, expression (1) for each candidate value of the offset of the three-axis acceleration sensor 112 is created. In this case, 9 candidate values are used for one axis, and so there are 9³ possible combinations for three axes. From there, 9³ expressions (1) are created. The processing unit 340 executes calculation of expressions (3) through (5) for each of the 9³ expressions (1).

The processing unit 340 inputs a predetermined value in GyroX_sns, GyroY_sns, GyroZ_sns of expression (6), and inputs the value derived in (2-2-1-1) to GyroX_ofs, GyroY_ofs, GyroZ_ofs of expression (6). GyroX_out, GyroY_out, GyroZ_out are the first output values. Further, the processing unit 340 derives 9³ yaw angles Ψ by executing the calculation of expressions (7) to (9) for each of the 9³ expressions (5). The processing unit 340 derives the angular speed from the yaw angle Ψ and derives the integral value of the angular speed as an orientation change (hereinafter referred to as “autonomous navigation orientation change”). 9³ patterns of autonomous navigation orientation change are determined.

Meanwhile, the processing unit 340 uses the GNSS orientation among the positioning results stored in the storage unit 320 to derive an orientation change during the autonomous navigation calculation period (hereinafter referred to as “satellite navigation orientation change”). Since a known technology may be used to derive the satellite navigation orientation change, a description thereof is omitted here. Given that the autonomous navigation orientation change is called the “first orientation change”, the satellite navigation orientation change is called the “second orientation change”. The processing unit 340 derives an absolute value of the difference (hereinafter referred to as a “absolute difference”) between the autonomous navigation orientation change and the satellite navigation orientation change for each autonomous navigation orientation change. The processing unit 340 compares the magnitude of the absolute differences and sets the candidate value of the offset of the three-axis acceleration sensor 112 used in the smallest absolute difference as the third initial value. For example, the candidate value “a5” in FIG. 3A is set as the third initial value.

The processing unit 340 then sets the initial tolerable range again with the third initial value as the median value. In this process, the initial tolerable range is configured to be narrower than before. FIG. 3B shows the newly set initial tolerable range “A2”. The initial tolerable range “A2” is set with the third initial value “a5” as the median value. Further, the initial tolerable range “A2” has a width between “a4” and “a6” and so is configured to be narrower than the initial tolerable range “A1”. The processing unit 340 places the nine candidate values at equal intervals within the initial tolerable range “A2”. The subsequent process is the same as before, and the third initial value is updated with the candidate value of the offset of the three-axis acceleration sensor 112 used in the autonomous navigation orientation change closest to the satellite navigation orientation change.

The processing unit 340 repeats such a process until the convergence condition is satisfied and identifies the third initial value when the convergence condition is satisfied. In this process, the processing unit 340 narrows the initial tolerable range further each time the process is repeated. The convergence condition requires that the absolute difference for the updated third initial value is larger than the absolute difference for the third initial value before the update. Thus, the processing unit 340 searches for the third initial value, narrowing the initial tolerable range in steps.

It will be noted here that the accuracy is improved, and the absolute difference (the smallest value among the candidate values) is reduced by narrowing the range (initial tolerable range) in which the search is performed for the initial value. When the search is converged, on the other hand, the absolute difference does not change even if the search range is narrowed to increase the accuracy. Based on the foregoing, the convergence condition should require that the absolute difference after the update becomes larger because a larger absolute difference is due to a calculation error. The convergence condition is not limited to the above and may require that the variance of the absolute difference in each candidate value is equal to or smaller than a predetermined value, or that the candidate value differs depending on different measurement data samples (first output value, second output value).

### (2-2-1-3) Process for the Sensitivity Coefficient of the Three-Axis Angular Speed Sensor 110

In this case, GyroX_sns, GyroY_sns, GyroZ_sns in expression (6) are the parameters to be determined. The processing unit 340 assumes that AcclX_sns, AcclY_sns, AcclZ_sns in expression (2) are equal. Further, the values obtained in (2-2-1-2) are input to AcclX_ofs, AcclY_ofs, AcclZ_ofs. Further, AcclX_out, AcclY_out, AcclZ_out are the second output values. The processing unit 340 executes calculation of expression (1) and expression (3) through expression (5) based on expression (2) as described above.

The processing unit 340 inputs the values derived in (2-2-1-1) to GyroX_ofs, GyroY_ofs, GyroZ_ofs of expression (6). GyroX_out, GyroY_out, GyroZ_out are the first output values. The processing unit 340 sets the initial tolerable range for each of GyroX_sns, GyroY_sns, GyroZ_sns in the same manner as when determining AcclX_ofs, etc. and places a plurality of (e.g., “nine”) candidate values of the sensitivity coefficient of the three-axis angular speed sensor 110 within the range. The value of the initial tolerable range may be different from the value of the initial tolerable range for AcclX_ofs, etc. Further, the number of candidate values is not limited to “9”. As a result, 9³ expressions (6) are created.

The processing unit 340 derives 9³ yaw angles Ψ by executing the calculation of expression (7) through expression (9) using the 9³ expressions (6). The processing unit 340 derives 9³ patterns of autonomous navigation orientation change and satellite navigation orientation change as in the foregoing. The processing unit 340 derives the absolute difference for each autonomous navigation orientation change. The processing unit 340 compares the magnitude of the absolute differences and sets the candidate value of the sensitivity coefficient of the three-axis angular speed sensor 110 used in the smallest absolute difference as the second initial value.

The processing unit 340 then sets the initial tolerable range again with the second initial value as the median value. In this process, the initial tolerable range is configured to be narrower than before. The subsequent process is the same as before, and the second initial value is updated with the candidate value of the sensitivity coefficient of the three-axis angular speed sensor 110 used in the autonomous navigation orientation change closest to the satellite navigation orientation change. The processing unit 340 repeats such a process until the convergence condition is satisfied and identifies the second initial value when the convergence condition is satisfied.

### (2-2-1-4) Process for the Sensitivity Coefficient of the Three-Axis Acceleration Sensor 112

In this case, AcclX_sns, AcclY_sns, AcclZ_sns in expression (2) are the parameters to be determined. The processing unit 340 sets the initial tolerable range for each of AcclX_sns, AcclY_sns, AcclZ_sns in the same manner as when determining AcclX_ofs, etc. and places a plurality of (e.g., “nine”) candidate values of the sensitivity coefficient of the three-axis acceleration sensor 112 within the range. Further, AcclX_out, AcclY_out, AcclZ_out are the second output values. Further, the values obtained in (2-2-1-2) are input to AcclX_ofs, AcclY_ofs, AcclZ_ofs. As a result, 9³ expressions (1) are created. The processing unit 340 executes the calculation of expressions (3) to (5) for each of the 9³ expressions (1).

The processing unit 340 inputs the values derived in (2-2-1-3) to GyroX_sns, GyroY_sns, GyroZ_sns of expression (6). Further, the processing unit 340 inputs the values derived in (2-2-1-1) to GyroX_ofs, GyroY_ofs, GyroZ_ofs of expression (6). Further, GyroX_out, GyroY_out, GyroZ_out are the first output values.

The processing unit 340 derives 9³ yaw angles Ψ by executing the calculation of expression (7) through expression (9) using the 9³ expressions (6). The processing unit 340 derives 9³ patterns of autonomous navigation orientation change and satellite navigation orientation change as in the foregoing. The processing unit 340 derives the absolute difference for each autonomous navigation orientation change. The processing unit 340 compares the magnitude of the absolute differences and sets the candidate value of the sensitivity coefficient of the three-axis acceleration sensor 112 used in the smallest absolute difference as the fourth initial value.

The processing unit 340 then sets the initial tolerable range again with the fourth initial value as the median value. In this process, the initial tolerable range is configured to be narrower than before. The subsequent process is the same as before, and the fourth initial value is updated with the candidate value of the sensitivity coefficient of the three-axis acceleration sensor 112 used in the autonomous navigation orientation change closest to the satellite navigation orientation change. The processing unit 340 repeats such a process until the convergence condition is satisfied and identifies the fourth initial value when the convergence condition is satisfied.

### (2-2-2) Process in the Second and Subsequent Laps

### (2-2-1-1) Process for the Offset of the Three-Axis Angular Speed Sensor 110

In this case, GyroX_ofs, GyroY_ofs, GyroZ_ofs in expression (6) are the parameters to be determined. The values obtained in (2-2-1-4) are input to AcclX_sns, AcclY_sns, AcclZ_sns in expression (2). Further, AcclX_out, AcclY_out, AcclZ_out are the second output values. Further, the values obtained in (2-2-1-2) are input to AcclX_ofs, AcclY_ofs, AcclZ_ofs. The processing unit 340 executes calculation of expression (1) and expression (3) through expression (5) based on expression (2) as described above.

The values obtained in (2-2-1-3) are input to GyroX_sns, GyroY_sns, GyroZ_sns in expression (6). Further, GyroX_out, GyroY_out, GyroZ_out are the first output values. Further, the processing unit 340 sets the initial tolerable range for each of GyroX_ofs, GyroY_ofs, GyroZ_ofs in the same manner as when determining AcclX_ofs, etc. and places a plurality of (e.g., “nine”) candidate values of the offset of three-axis angular speed sensor 110 within the range. The value of the initial tolerable range may be different from the value of the initial tolerable range for AcclX_ofs, etc. Further, the number of candidate values is not limited to “9”. As a result, 9³ expressions (6) are created.

The processing unit 340 derives 9³ yaw angles Ψ by executing the calculation of expression (7) through expression (9) using the 9³ expressions (6). The processing unit 340 derives 9³ patterns of autonomous navigation orientation change and satellite navigation orientation change as in the foregoing. The processing unit 340 derives the absolute difference for each autonomous navigation orientation change. The processing unit 340 compares the magnitude of the absolute differences and sets the candidate value of the offset of the three-axis angular speed sensor 110 used in the smallest absolute difference as the first initial value.

The processing unit 340 then sets the initial tolerable range again with the first initial value as the median value. In this process, the initial tolerable range is configured to be narrower than before. The subsequent process is the same as before, and the first initial value is updated with the candidate value of the offset of the three-axis angular speed sensor 110 used in the autonomous navigation orientation change closest to the satellite navigation orientation change. The processing unit 340 repeats such a process until the convergence condition is satisfied and identifies the first initial value when the convergence condition is satisfied.

Given that the initial tolerable range used to determine the first initial value is referred to as the “first initial tolerable range”, the initial tolerable ranges used to determine the second initial value through the fourth initial value are referred to as “second initial tolerable range”, “third initial tolerable range”, and “fourth initial tolerable range”. Further, the first initial tolerable range, the second initial tolerable range, the third initial tolerable range, and the fourth initial tolerable range are collectively referred to as the initial tolerable range.

### (2-2-2-2) Process for Offset of Three-Axis Acceleration Sensor 112

### (2-2-2-3) Process for the Sensitivity Coefficient of Three-Axis Angular Speed Sensor 110

### (2-2-2-4) Process for the Sensitivity Coefficient of the Three-Axis Acceleration Sensor 112

The same process as executed in the first lap is executed. In this process, the initial tolerable range at the start may be narrower than the initial tolerable range at the end of the first lap. The processing unit 340 executes such a process in a predetermined number of laps.

Thus, the processing unit 340 uses the first output value, the second output value, and the positioning result to search for the first initial value of the offset of the three-axis angular speed sensor 110 within the first initial tolerable range and search for the second initial value of the offset of the three-axis angular speed sensor 110 within the second initial tolerable range. Further, the processing unit 340 uses the first output value, the second output value, and the positioning result to search for the third initial value of the offset of the three-axis acceleration sensor 112 within the third initial tolerable range and search for the fourth initial value of the sensitivity coefficient of the three-axis acceleration sensor 112 within the fourth initial tolerable range.

When the first initial value through the fourth initial value are determined by the search process described above, the communication unit 330 transmits the first initial value, the second initial value, the third initial value, the fourth initial value, the first initial tolerable range, the second initial tolerable range, the third initial tolerable range, and the fourth initial tolerable range to the terminal apparatus 100.

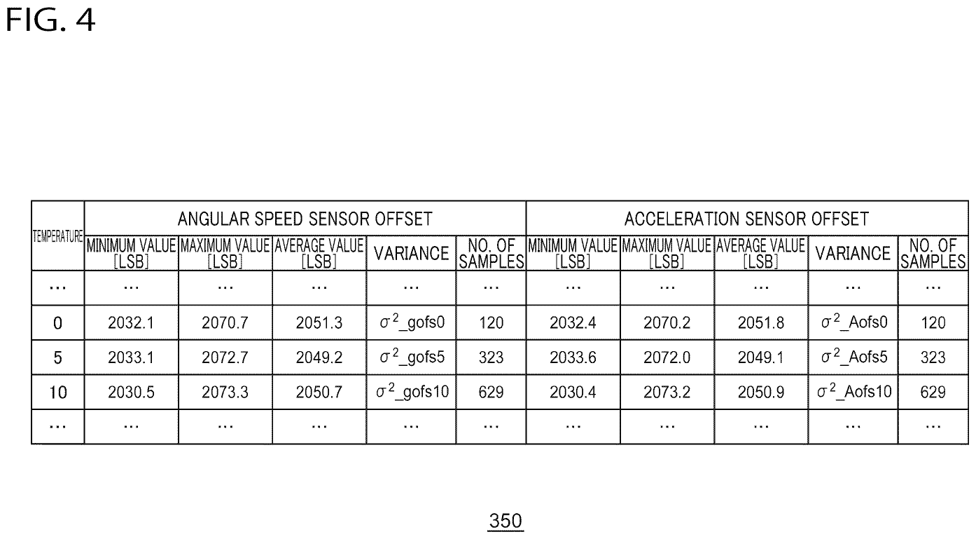

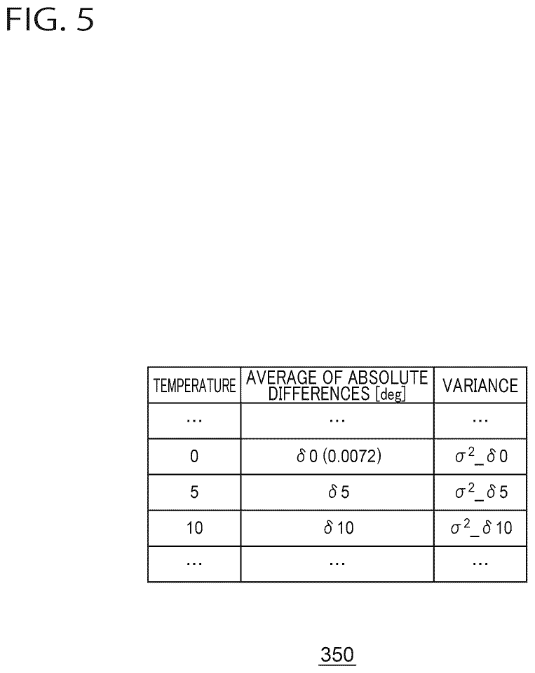

The statistical processing unit 350 generates statistical information by executing a statistical process based on the first initial value through the fourth initial value derived by the processing unit 340. For example, the statistical processing unit 350 generates statistical information each time the first initial value through the fourth initial value are respectively determined for the plurality of terminal apparatuses 100. FIG. 4 shows a data structure of a database generated by the statistical processing unit 350. The statistical information on the offset of the three-axis angular speed sensor 110 and the statistical information on the offset of the three-axis acceleration sensor 112 are shown for each temperature, which is the third output value. The statistical information on the sensitivity coefficient of the three-axis angular speed sensor 110 and the statistical information on the sensitivity coefficient of the three-axis acceleration sensor 112 may be shown in the same way. FIG. 5 shows a data structure of another database generated by the statistical processing unit 350. The average of absolute differences, etc. are shown for each temperature. Reference is made back to FIG. 1.

The initial tolerable range in the initial state is determined based on the device characteristics. When statistical information is generated by the statistical processing unit 350, the initial tolerable range and the median value are determined based on the statistical information. For example, three times the variance is defined as the initial tolerable range, and the average value is defined as the median value.

The communication unit 130 of the terminal apparatus 100 receives the first initial value, the second initial value, the third initial value, the fourth initial value, the first initial tolerable range, the second initial tolerable range, the third initial tolerable range, and the fourth initial tolerable range from the server 300. The storage unit 120 stores the first initial value, the second initial value, the third initial value, the fourth initial value, the first initial tolerable range, the second initial tolerable range, the third initial tolerable range, and the fourth initial tolerable range received by the communication unit 130.

The processing unit 140 executes the same process as executed by the processing unit 340 by using a new first output value, a new second output value, and a new positioning result. That is, the processing unit 140 searches for the offset of the three-axis angular speed sensor 110 based on the first initial value within the first tolerable range narrower than the first initial tolerable range and searches for the sensitivity coefficient of the three-axis angular speed sensor 110 based on the second initial value within the second tolerable range narrower than the second initial tolerable range. Further, the processing unit 140 searches for the offset of the three-axis acceleration sensor 112 based on the third initial value within the third tolerable range narrower than the third initial tolerable range and searches for the sensitivity coefficient of the three-axis acceleration sensor 112 based on the fourth initial value within the fourth tolerable range narrower than the fourth initial tolerable range. The first tolerable range, the second tolerable range, the third tolerable range, and the fourth tolerable range are collectively referred to as the tolerable range.

This corresponds to deriving the offset and the sensitivity coefficient that track a temperature drift based on the first initial value through the fourth initial value received from the server 300. In this process, the number of candidate values set in each tolerable range is configured to be smaller than the number (e.g., “9”) of candidate values set in the processing unit 340. By way of one example, the number of candidate values set in each tolerable range is set to “3”. Further, the communication unit 130 may receive the statistical information from the server 300. In this process, the processing unit 140 sets the tolerable range and the median value based on the statistical information.

The processing unit 140 derives the angular speed based on the offset of the three-axis angular speed sensor 110, the sensitivity coefficient of the three-axis angular speed sensor 110, the offset of the three-axis acceleration sensor 112, and the sensitivity coefficient of the three-axis acceleration sensor 112. Derivation of the angular speed may be performed as described above, and so a description thereof is omitted here.

The processing unit 140 derives the integral value of the angular speed as an autonomous navigation orientation change and derives a satellite navigation orientation change based on the positioning result. When the difference between the autonomous navigation orientation change and the satellite navigation orientation change becomes larger than a threshold value, the communication unit 130 transmits a request signal to the server 300 for requesting a re-search for the first initial value through the fourth initial value. Further, the processing unit 140 may derive the difference between the first temperature measured by the temperature sensor 116 when the first output value, the second output value, and the positioning result are acquired and the current, second temperature measured by the temperature sensor 116. When the difference becomes larger than the threshold value, the communication unit 130 transmits a request signal to the server 300 for requesting a re-search for the first initial value through the fourth initial value. The request signal may include error information. These steps correspond to requesting the server 300 to re-search for the first initial value through the fourth initial value when a tracking error is detected in the processing unit 140.

The processing unit 140 sets the temperature flag to “1” when the temperature change in the terminal apparatus 100 is equal to or larger than a predetermined value. Further, the processing unit 140 sets an error flag to “1” when the difference between the autonomous navigation orientation change and the satellite navigation orientation change in the terminal apparatus 100 becomes larger than a predetermined value. The predetermined value is set by the statistical value acquired from the server 300. In the case the initial value derived by the server 300 at each temperature is stored in the storage unit 120 of the terminal apparatus 100 and the initial value at the post-change temperature (second temperature) is not stored in the storage unit 120 (when it is not derived by the server 300), the temperature flag may be set to “1”.

Each terminal apparatus 100 stores the first initial value through the fourth initial value acquired from the server 300 in the past along with the temperature (first temperature) in the storage unit 120. When a temperature change occurs, the first initial value, etc. may be derived based on the stored initial value if the first initial value, etc. at the post-change temperature (second temperature) is not stored. In this process, the terminal apparatus 100 does not request the server 300 to conduct a re-search. The requirement for re-search may be determined based on a combination of the temperature change and the error change.

When the communication unit 330 of the server 300 receives the request signal from the terminal apparatus 100, the processing unit 340 re-searches for the first initial value through the fourth initial value by executing the same process as before. Subsequently, the communication unit 330 of the server 300 transmits the first initial value through the fourth initial value identified by the re-search to the terminal apparatus 100. The communication unit 130 of the terminal apparatus 100 receives the first initial value through the fourth initial value identified by the re-search from the server 300, and the processing unit 140 executes the same process as before for the first initial value through the fourth initial value identified by the re-search.

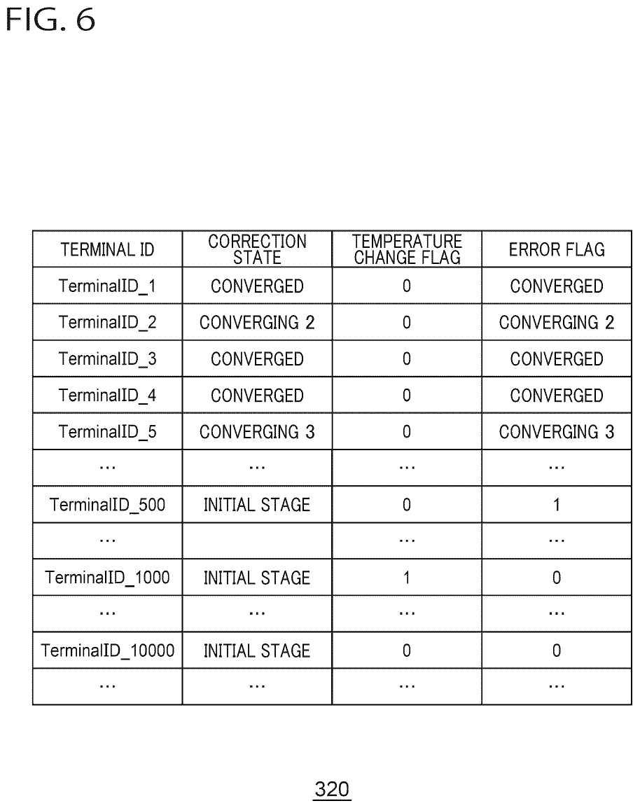

The communication unit 330 may be capable of communicating with a plurality of terminal apparatuses 100. The storage unit 320 manages the state of each terminal apparatus 100. FIG. 6 shows a data structure of a database stored in the storage unit 320. The database shows a correction state, a temperature change flag, and an error flag for each terminal apparatus 100. The correction state indicates the correction state for each terminal apparatus 100 in the server 300, the temperature flag is information indicating a temperature change in the terminal apparatus 100, and the error flag is information indicating an error state in the terminal apparatus 100. The correction state for terminals with TerminalID_1, TerminalID_3, TerminalID_4 indicates a state in which the first initial value through the fourth initial value are derived in the search process and transmitted to the terminal apparatus 100. Further, the correction state for terminals with TerminalID_2, TerminalID_5 indicates a state in which the initial value is being derived, and the correction state for TerminalID_500, TerminalID_1000, TerminalID_10000 indicates a state in which the initial value has not been derived. Reference is made back to FIG. 1.

The processing unit 340 determines the priority of the terminal apparatus 100 for which the search process is executed, based on the correction state, error flag, and temperature flag in the table as described above. For example, the processing unit 340 prioritizes derivation of the initial value of the terminal apparatus 100 having the error flag of “1” over the terminal apparatus 100 having the temperature flag of “1” and the error flag of “0”. Further, the processing unit 340 may prioritize the terminal apparatus 100 having the initial correction state.

The processing unit 340 may determine the priority in accordance with the correction state, temperature flag, and error flag of each terminal apparatus 100 at each temperature. When the correction state is “converged”, for example, the processing unit 340 sets the priority low even if the temperature flag is “1” because the initial value data for the temperature is stored in the terminal apparatus 100. Further, when the temperature flag and the error flag are “1” and the correction state is “initial”, the processing unit 340 sets a high priority because the terminal apparatus 100 does not store the initial value at the temperature, and the error due to the temperature change has become larger. That is, the processing unit 340 preferentially searches for the first initial value through the fourth initial value for the terminal apparatus 100, among the plurality of terminal apparatuses 100, to which the first initial value through the fourth initial value and the first initial tolerable range through the fourth initial tolerable range have not been transmitted.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

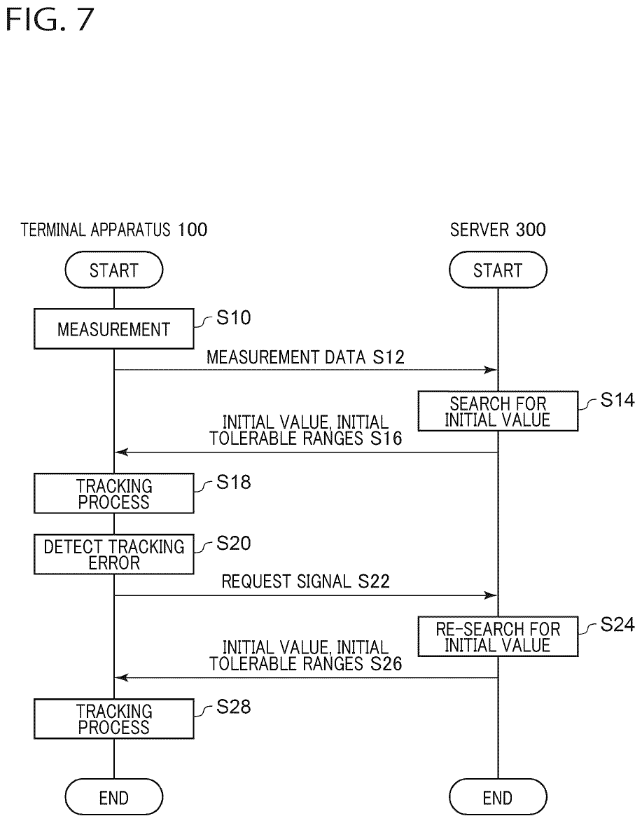

The operation of the correction system 1000 having the above configuration will be described. FIG. 7 is a sequence chart showing the steps of deriving the angular speed by the correction system 1000. The terminal apparatus 100 executes measurement by the three-axis angular speed sensor 110, the three-axis acceleration sensor 112, the GNSS positioning unit 114, and the temperature sensor 116 (S10). The terminal apparatus 100 transmits the measurement data to the server 300 (S12). The server 300 searches for the initial value (S14). The server 300 transmits the initial value and the initial tolerable range to the terminal apparatus 100 (S16). The terminal apparatus 100 executes a tracking process (S18). When the terminal apparatus 100 detects a tracking error (S20), the terminal apparatus 100 transmits a request signal to the server 300 (S22). The server 300 re-searches for the initial value (S24). The server 300 transmits the initial value and the initial tolerable range to the terminal apparatus 100 (S26). The terminal apparatus 100 executes a tracking process (S28).

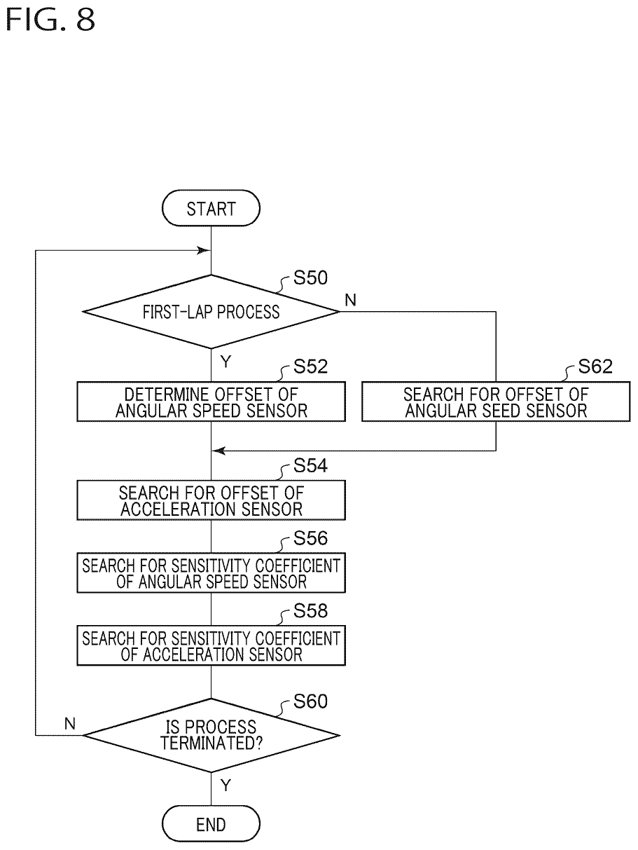

FIG. 8 is a flowchart showing the steps of deriving the offset and the sensitivity coefficient by the server 300. In the case of the first lap process (Y in S50), the processing unit 340 determines the offset of the three-axis angular speed sensor 110 (S52). The processing unit 340 searches for the offset of the three-axis acceleration sensor 112 (S54), searches for the sensitivity coefficient of the three-axis angular speed sensor 110 (S56), and searches for the sensitivity coefficient of the three-axis acceleration sensor 112 (S58). If the process is not terminated (N in S60), the process returns to step 50. In the case the process is not the first lap process (N in S50), the processing unit 340 searches for an offset of the three-axis angular speed sensor 110 (S62). The processing unit 340 executes step 54 through step 58 in order. If the process is terminated (Y of S60), the process ends.

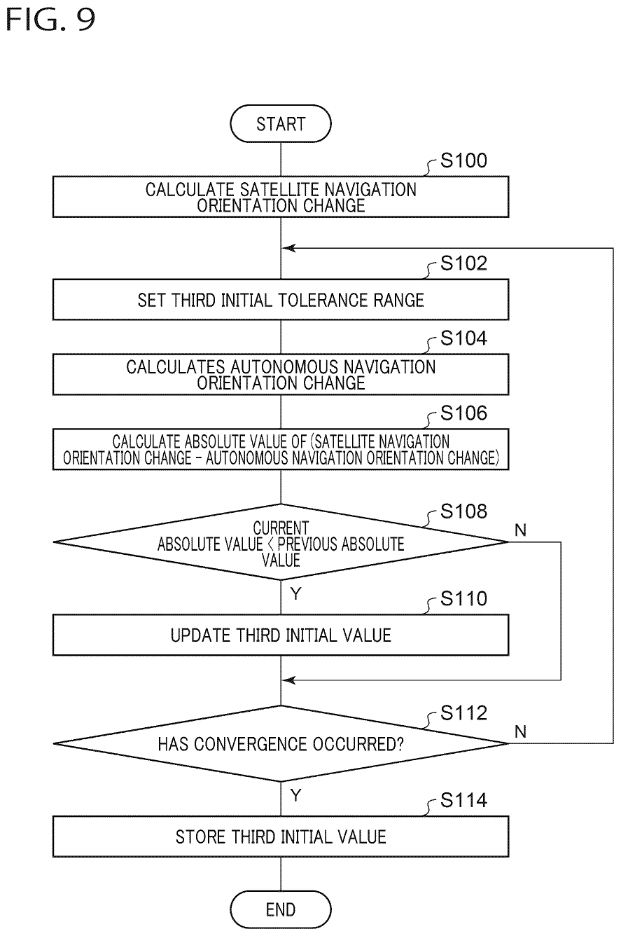

FIG. 9 is a flowchart showing the steps of deriving the third initial value by the server 300. This corresponds to the process of step 54 of FIG. 8. The processing unit 340 calculates the satellite navigation orientation change (S100). The processing unit 340 sets the third initial tolerable range (S102) and calculates the autonomous navigation orientation change (S104). The processing unit 340 calculates the absolute value of (satellite navigation orientation change-autonomous navigation orientation change) (S106). When the current absolute value is smaller than the previous absolute value (Y in S108), the processing unit 340 updates the third initial value (S110). When the current absolute value is not smaller than the previous absolute value (N in S108), step 110 is skipped. In the case convergence has not occurred (N in S112), the process returns to step 102. In the case convergence has occurred (Y in S112), the processing unit 340 stores the third initial value (S114).

According to the exemplary embodiment of the present disclosure, the initial value of the offset and the initial value of the sensitivity coefficient of the three-axis angular speed sensor and the three-axis acceleration sensor are determined in the server, and the offset and sensitivity coefficient of the three-axis angular speed sensor and the three-axis acceleration sensor are determined in the terminal apparatus based on the initial values. Accordingly, the process can be shared between the server and the terminal apparatus. Further, the process is shared between the server and the terminal apparatus so that the offset and the sensitivity coefficient can be determined while reducing the load on the server. Further, determination of the initial value of the offset and the initial value of the sensitivity coefficient, which require a larger processing amount, is executed in the server, and determination of the offset and the sensitivity coefficient, which require a smaller processing amount, is executed in the terminal apparatus so that the angular speed can be efficiently derived. Further, determination of the initial value, which requires a large processing amount, is executed in the server so that the determination accuracy can be improved compared to the case where the offset and the sensitivity coefficient are determined only in the terminal apparatus.

Further, the initial tolerable range is configured to be narrower each time the process for searching for the initial value is repeated so that the search accuracy can be improved. Further, the initial tolerable range is configured to be narrower each time the process for searching for the offset and the sensitivity coefficient is repeated so that the search accuracy can be improved. Further, the initial tolerable range is configured to be narrower based on statistical information so that the angular speed can be efficiently derived.

Further, the terminal apparatus requests the server to re-search for the first initial value through the fourth initial value when the difference between the autonomous navigation orientation change and the satellite navigation orientation change becomes larger than the threshold value so that deterioration of the accuracy of angular speed derivation can be suppressed. Further, the terminal apparatus requests the server to re-search for the first initial value through the fourth initial value when the temperature change is large so that deterioration of the accuracy of angular speed derivation can be suppressed. Further, the server prioritizes the process for the terminal apparatus, among the plurality of terminal apparatuses, to which the first initial value through the fourth initial value have not been transmitted so that the accuracy of the correction system can be improved.

Described above is an explanation of the present disclosure based on an exemplary embodiment. The exemplary embodiment is intended to be illustrative only and it will be understood by those skilled in the art that various modifications to constituting elements and processes could be developed and that such modifications are also within the scope of the present disclosure.

The processing unit 340 and the processing unit 140 in the exemplary embodiment determine convergence by referring to the absolute difference between the autonomous navigation orientation change and the satellite navigation orientation change. Alternatively, the processing unit 340 and the processing unit 140 may derive the absolute difference between the autonomous navigation speed change and the satellite navigation speed change and determine convergence by referring to the absolute difference. According to this variation, flexibility of the configuration can be improved.

The terminal apparatus 100 in the exemplary embodiment may derive the angular speed, acceleration, attitude angle, and speed based on the parameters including the offset/sensitivity coefficient of the three-axis angular speed sensor 110 and the offset/sensitivity coefficient of the three-axis acceleration sensor 112 derived by the processing unit 140. To describe it specifically, the output unit provided in the terminal apparatus 100 sequentially derives the attitude angle, angular speed, and speed by using the parameters including the offset (GyroX_ofs, GyroY_ofs, GyroZ_ofs) of the three-axis angular speed sensor 110, the sensitivity coefficient (GyroX_sns, GyroY_sns, GyroZ_sns) of the three-axis angular speed sensor 110, the offset (AcclX_ofs, AcclY_ofs, AcclZ_ofs) of the three-axis acceleration sensor 112, and the sensitivity coefficient (AcclX_sns, AcclY_sns, AcclZ_sns) of the three-axis acceleration sensor 112 from the processing unit 140.

The attitude angle and the angular speed are calculated by the method described in (1) Basic process for deriving the angular speed. Further, the speed is calculated from ax and the pitch angle θ. Since the acceleration of the movable body and the pitch angle component of the gravitational acceleration are superimposed on the acceleration sensor x-axis, the following relationship holds given that the acceleration of the movable object in the coordinate system is denoted by a.

$$ax = a - g / sin θ$$

This is modified as follows.

$$\begin{matrix}{a}^{} = ax + g \cdot sin θ \\ = AcclX\_sns \cdot ( AcclX\_out - AcclX\_ofs ) + g \cdot sin θ\end{matrix}$$

The speed is determined by integrating the acceleration with the initial speed in the stopped state being “0”. Further, given that the acceleration in the coordinate system defined with reference to the horizontal plane of the earth's surface is denoted by a′, a′ is calculated as the integral value of the following:

$$\begin{matrix}{a}^{{}_{′}} = a \cdot cos θ \\ = ( AcclX\_sns \cdot ( AcclX\_out - AcclX\_ofs ) + g \cdot sin ) \cdot cos θ\end{matrix}$$

According to this variation, flexibility of the configuration can be improved.

What is claimed is:

1. A correction system comprising:
a terminal apparatus comprising a three-axis angular speed sensor, a three-axis acceleration sensor, and a GNSS (Global Navigation Satellite System) positioning unit; and
a server capable of communicating with the terminal apparatus,
wherein the terminal apparatus transmits a first output value of the three-axis angular speed sensor, a second output value of the three-axis acceleration sensor, and a positioning result of the GNSS positioning unit to the server,
wherein the server uses the first output value, the second output value, and the positioning result to search for a first initial value of an offset of the three-axis angular speed sensor within a first initial tolerable range, search for a second initial value of a sensitivity coefficient of the three-axis angular speed sensor within a second initial tolerable range, search for a third initial value of an offset of the three-axis acceleration sensor within a third initial tolerable range, and search for a fourth initial value of a sensitivity coefficient of the three-axis acceleration sensor within a fourth initial tolerable range,
wherein the server transmits the first initial value, the second initial value, the third initial value, the fourth initial value, the first initial tolerable range, the second initial tolerable range, the third initial tolerable range, and the fourth initial tolerable range to the terminal apparatus,
wherein the terminal apparatus uses a new first output value, a new second output value, and a new positioning result to search for the offset of the three-axis angular speed sensor based on the first initial value within a first tolerable range narrower than the first initial tolerable range, search for the sensitivity coefficient of the three-axis angular speed sensor based on the second initial value within a second tolerable range narrower than the second initial tolerable range, search for the offset of the three-axis acceleration sensor based on the third initial value within a third tolerable range narrower than the third initial tolerable range, and search for the sensitivity coefficient of the three-axis acceleration sensor based on the fourth initial value within a fourth tolerable range narrower than fourth initial tolerable range the fourth initial tolerable range, and
wherein the terminal apparatus derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.

2. The correction system according to claim 1,
wherein the terminal apparatus derives an integral value of the angular speed as a first orientation change, derives a second orientation change based on the positioning result, and transmits a request signal for requesting re-search of the first initial value, the second initial value, the third initial value, and the fourth initial value to the server when a difference between the first orientation change and the second orientation change becomes larger than a threshold value.

3. The correction system according to claim 1,
wherein the terminal apparatus further includes a temperature sensor,
wherein the terminal apparatus transmits a request signal for requesting re-search of the first initial value, the second initial value, the third initial value, and the fourth initial value to the server when a difference between i) a first temperature measured by the temperature sensor at the time the terminal apparatus acquires the first output value, the second output value, and the positioning result and ii) a a current, second temperature measured by the temperature sensor becomes larger than a threshold value.

4. The correction system according to claim 1,
wherein the server is capable of communicating with a plurality of terminal apparatuses,
wherein the server preferentially searches for the first initial value, the second initial value, the third initial value, the fourth initial value for the terminal apparatus, among the plurality of terminal apparatuses, to which the first initial value, the second initial value, the third initial value, and the fourth initial value, the first initial tolerable range, the second initial tolerable range, the third initial tolerable range, and the fourth initial tolerable range have not been transmitted.

5. The correction system according to claim 1,
wherein the server:
after searching for the first initial value of the offset of the three-axis angular speed sensor within the first initial tolerable range, searches for the third initial value of the offset of the three-axis acceleration sensor within the third initial tolerable range,
after searching for the third initial value, searches for the second initial value of the sensitivity coefficient of the three-axis angular speed sensor within the second initial tolerable range, and
after searching for the second initial value, searches for the fourth initial value of the sensitivity coefficient of the three-axis acceleration sensor within the fourth initial tolerable range.

6. The correction system according to claim 1,
wherein the server:
after searching for the first initial value within the first initial tolerable range by using the first output value, the second output value, and the positioning result, uses the first initial value search for the third initial value of the offset of the three-axis acceleration sensor within the third initial tolerable range;
after searching for the third initial value, uses the first initial value and the third initial value to search for the second initial value of the sensitivity coefficient of the three-axis angular speed sensor within the second initial tolerable range, and
after searching for the second initial value, uses the first initial value, the second initial value, and the third initial value to search for the fourth initial value of the sensitivity coefficient of the three-axis acceleration sensor within the fourth initial tolerable range.

7. The correction system according to claim 1,
wherein, in a search for the first initial value, the second initial value, the third initial value, and the fourth initial value, the server calculates a plurality of candidate values for each initial value in each initial tolerable range and defines, as the initial value, a candidate value that results in the smallest difference between an orientation change based on an angular speed derived from the plurality of candidate values and an orientation change based on the positioning result.

8. The correction system according to claim 7,
wherein, in a search for the first initial value, the second initial value, the third initial value, and the fourth initial value, the server re-sets each initial tolerable range based on each calculated initial value, re-searches for each initial value in each re-set initial tolerable range, and updates each initial value by a value identified by a re-search.

9. The correction system according to claim 8,
wherein, in a search for the first initial value, the second initial value, the third initial value, and the fourth initial value, the server repeats a re-search in each initial tolerable range that is re-set based on each value identified by a re-search, until each initial value identified by a re-search satisfies a predetermined convergence condition.

10. The correction system according to claim 9,
wherein the predetermined convergence condition requires that a difference between an orientation change based on an angular speed derived from each updated initial value and an orientation change based on the positioning result is larger than a difference between an orientation change based on an angular speed derived from each pre-update initial value and an orientation change based on the positioning result.

11. The correction system according to claim 1,
wherein the terminal apparatus further includes a temperature sensor,
wherein the terminal apparatus transmits a first temperature measured by the temperature sensor to the server at the time the terminal apparatus acquires the first output value, the second output value, and the positioning result,
wherein the server further includes a statistical processing unit that generates statistical information based on the first initial value, the second initial value, the third initial value, and the fourth initial value, and
wherein the statistical information is generated by statistics of the first initial value, the second initial value, the third initial value, and the fourth initial value at each first temperature.

12. The correction system according to claim 11,
wherein the server determines the first initial tolerable range, the second initial tolerable range, the third initial tolerable range, and the fourth initial tolerable range based on the statistical information on the first initial value, the second initial value, the third initial value, and the fourth initial value at each first temperature.

13. The correction system according to claim 11,
wherein the server transmits, as the first initial value, the second initial value, the third initial value, and the fourth initial value, a value based on the statistical information to the terminal apparatus.

14. A terminal apparatus comprising:
a three-axis angular speed sensor;
a three-axis acceleration sensor;
a GNSS (Global Navigation Satellite System) positioning unit;
a communication unit that transmits a first output value of the three-axis angular speed sensor, a second output value of the three-axis acceleration sensor, and a positioning result of the GNSS positioning unit to the server, and uses the first output value, the second output value, and the positioning result to receive a first initial value of an offset of the three-axis angular speed sensor searched for within a first initial tolerable range, a second initial value of a sensitivity coefficient of the three-axis angular speed sensor searched for within a second initial tolerable range, a third initial value of an offset of the three-axis acceleration sensor searched for within a third initial tolerable range, and a fourth initial value of a sensitivity coefficient of the three-axis acceleration sensor searched for within a fourth initial tolerable range; and
a processing unit that i) uses a new first output value, a new second output value, and a new positioning result to search for the offset of the three-axis angular speed sensor based on the first initial value within a first tolerable range narrower than the first initial tolerable range, search for the sensitivity coefficient of the three-axis angular speed sensor based on the second initial value within a second tolerable range narrower than the second initial tolerable range, search for the offset of the three-axis acceleration sensor based on the third initial value within a third tolerable range narrower than the third initial tolerable range, and search for the sensitivity coefficient of the three-axis acceleration sensor based on the fourth initial value within a fourth tolerable range narrower than fourth initial tolerable range the fourth initial tolerable range and ii) derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.

15. A program in a terminal apparatus including a three-axis angular speed sensor, a three-axis acceleration sensor, and a GNSS (Global Navigation Satellite System) positioning unit, the program comprising computer-implemented modules including:
a module that transmits a first output value of the three-axis angular speed sensor, a second output value of the three-axis acceleration sensor, and a positioning result of the GNSS positioning unit to the server, and uses the first output value, the second output value, and the positioning result to receive a first initial value of an offset of the three-axis angular speed sensor searched for within a first initial tolerable range, a second initial value of a sensitivity coefficient of the three-axis angular speed sensor searched for within a second initial tolerable range, a third initial value of an offset of the three-axis acceleration sensor searched for within a third initial tolerable range, and a fourth initial value of a sensitivity coefficient of the three-axis acceleration sensor searched for within a fourth initial tolerable range; and
a module that that i) uses a new first output value, a new second output value, and a new positioning result to search for the offset of the three-axis angular speed sensor based on the first initial value within a first tolerable range narrower than the first initial tolerable range, search for the sensitivity coefficient of the three-axis angular speed sensor based on the second initial value within a second tolerable range narrower than the second initial tolerable range, search for the offset of the three-axis acceleration sensor based on the third initial value within a third tolerable range narrower than the third initial tolerable range, and search for the sensitivity coefficient of the three-axis acceleration sensor based on the fourth initial value within a fourth tolerable range narrower than fourth initial tolerable range the fourth initial tolerable range and ii) derives an angular speed based on the offset of the three-axis angular speed sensor, the sensitivity coefficient of the three-axis angular speed sensor, the offset of the three-axis acceleration sensor, and the sensitivity coefficient of the three-axis acceleration sensor.
